(19) United States
(12) Patent Application Publication
(10) Pub. No.: US 2011/0309594 A1
(43) Pub. Date: Dec. 22, 2011

(54) Suspension system for hummer vehicle

(76) Inventor: Hadar Zohar, Tel Aviv (IL)

(21) Appl. No.: 13/134,348

(22) Filed: Jun. 7, 2011

(30) Foreign Application Priority Data
Jun. 13, 2010 (IL) 206320

(51) Int. Cl. B62D 21/11

(52) U.S. Cl. 280/124.109

(57) ABSTRACT

A suspension system for off-road vehicles that replaces the original suspension system and comprises an upper bracket and a bottom bracket that have a unique and innovative design and include holes that enable to attach the brackets using the original holes in the vehicle's chassis and axle.

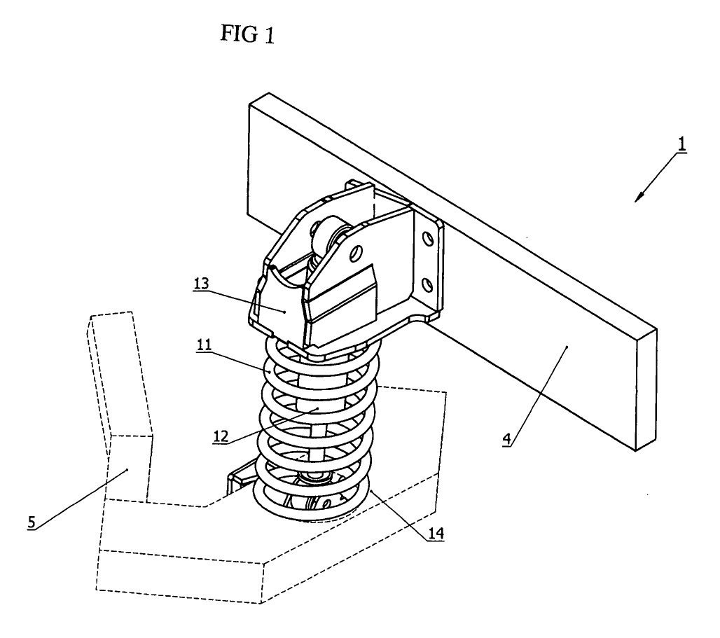

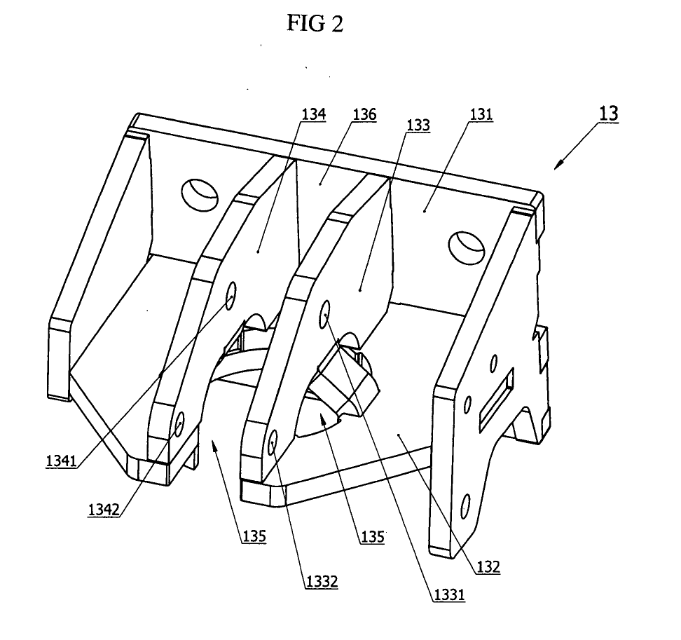

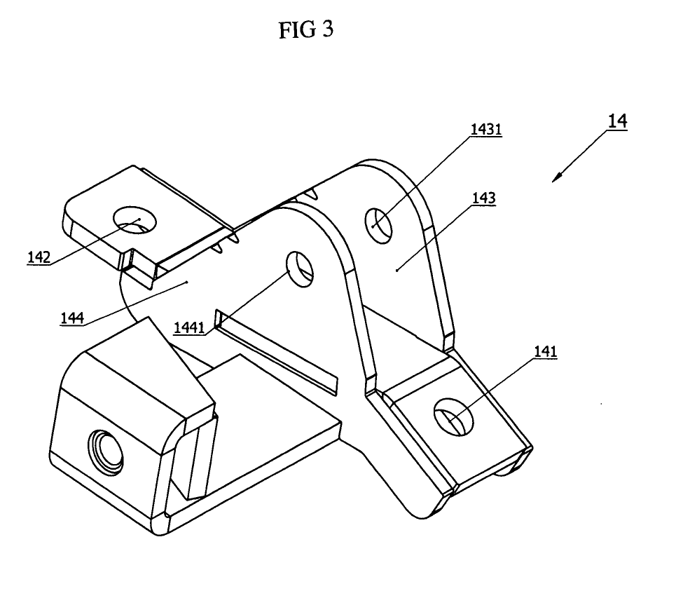

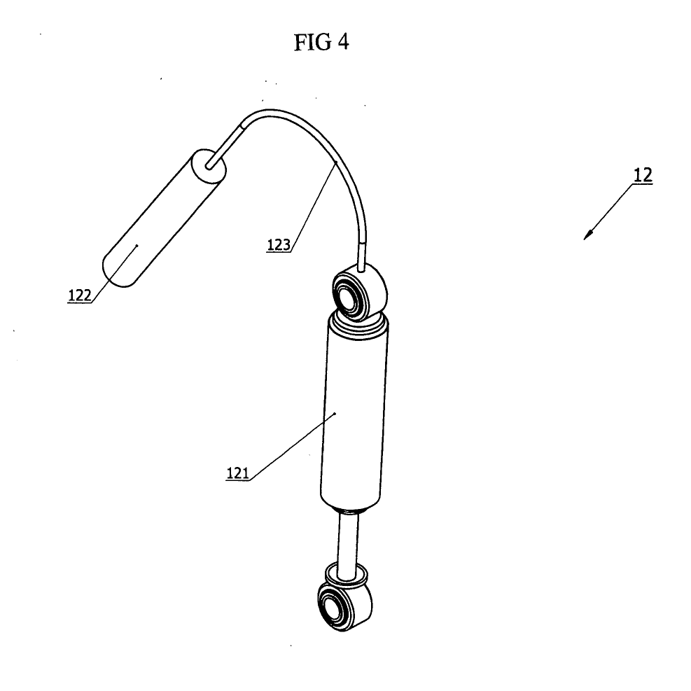

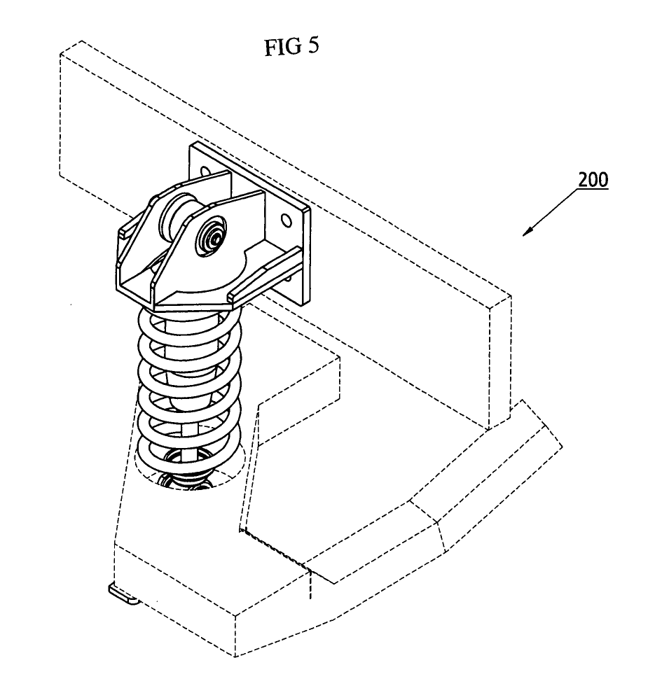

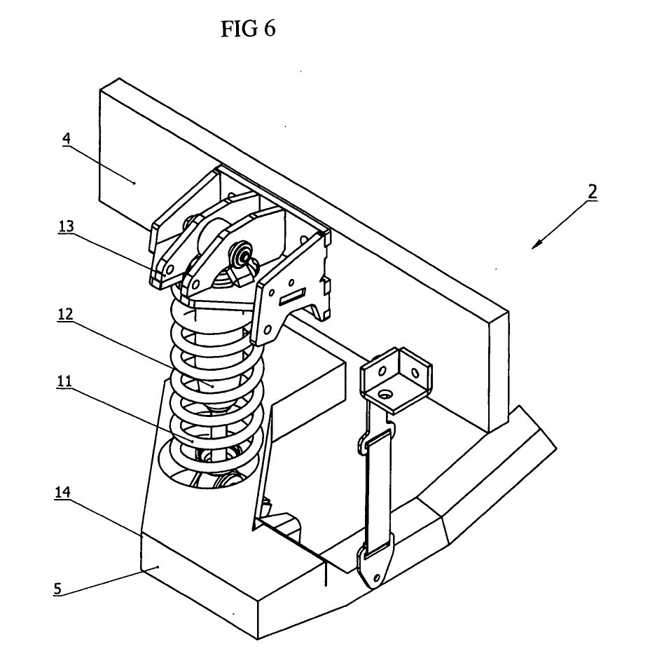

### TECHNICAL FIELD

The present invention refers to a vehicle suspension system that includes a coil spring and a shock absorber.

### BACKGROUND ART

All vehicles are equipped with suspension systems designed to provide comfort and stability on the road during travel. The term suspension system refers to a system of components that connect the chassis of the vehicle to the vehicle's wheel system. The suspension system usually includes a soil spring and a shock absorber. Four-wheel vehicles have a separate suspension system for each of the four wheels.

The main objective of the coil spring is to enable the vehicle (the chassis) to travel along a horizontal line that is as straight as possible, providing comfort of ride, while the vehicle's wheel system rises and falls vertically according to the bumps and the course of the road. The two main types of coil springs are regular or linear coil springs, which are referred to simply as coil springs, and progressive coil springs. The main function of the shock absorber is to restrain the periodic oscillations of the coil spring and induce constant wheel grip on the road surface. Any average professional in the field is familiar with the internal structure and mode of operation of both shock absorbers and coil springs (regular and progressive), and so detailed and wordy descriptions are unnecessary.

One end of the vehicle's suspension is attached to the body of the vehicle while the other end is attached to the vehicle's axle, which is a component of the vehicle's wheel system. The coil spring is usually not attached to the vehicle's chassis or axle in a fixed or permanent manner. The coil spring is positioned on the lower base which is adjacent to the axle and is compressed from above by the upper base, which is adjacent to the vehicle's body. Both ends of the shock absorber are attached to the vehicle, whereby the top of the shock absorber is attached to the chassis and the bottom is attached to the axle.

Vehicle manufacturers design special suspension systems for each vehicle model according to the vehicle's dimensions, weight, intended load, velocities and territory conditions the vehicle is designated for, among other things. The design of a special suspension system for a specific vehicle addresses the following main issues: (a) Components of the suspension system. Will it include a regular or progressive coil spring? Will it include a shock absorber, and if so, what kind (oil, gas, air). (b) Power rating of the coil spring and shock absorber. The power rating of a coil spring refers mainly to the spring constant which is measured in N/mm. The power rating of a shock absorber is measured in units of kgf (kilogram-force). (c) Geometric dimensions of the components: The diameter of the coil spring and its length in its decompressed state. The length of the shock absorber in its decompressed state (in other words, the distance between the two points at which it is attached to the vehicle's chassis and axle). (d) Parts designed to attach the shock absorber to holes in the chassis and axle, and the coil spring's brackets and their attachment to the chassis and axle. Professionals in the said field are, in general, familiar with all of the above, and thus no detailed explanations are necessary.

In many cases the vehicle is intended to travel under tough and unpaved terrain conditions and its driver must adjust the travel velocity to suit the terrain conditions. The tougher the terrain conditions, the lower the travel velocity must be. Replacing the vehicle's standard suspension system with an alternative system can constitute a possible solution to the said problem and can enable the vehicle to travel at a higher velocity under the same terrain conditions while providing the same driving comfort.

The invention, subject of the present application, refers to Hummer series off-road vehicles made by AM General and General Motors, which are also used by military forces. Therefore, and for the sake of fluidity of explanation, the term “vehicle” and/or “vehicles” will refer, in this application, to any Hummer series off-road vehicle manufactured by AM General and General Motors. The present invention is a suspension method and system for vehicles that is designed to offer a response to the problem of ride comfort when driving under tough terrain conditions.

### THE INVENTION

The present invention refers to a vehicle suspension system and method that is adapted to the vehicle with the objective of enabling faster and more comfortable travel under tough terrain conditions. The main objective of the present invention is to provide the vehicle with a front suspension system (1) and a rear suspension system (2) that offer a proper solution to the said problem. Another objective of the present invention is to provide suspension systems (1) (2) with a geometric configuration that enables the new brackets are connected directly to the vehicle's chassis and axle using the vehicle's original, existing holes.

The vehicle's standard front (left) suspension system (100) prior to adaptation. The suspension system is connected to the vehicle's chassis (4) and axle (5). The standard front suspension system (100) comprises a coil spring (101) and a shock absorber (102). The coil spring (101) is positioned between the lower bracket (103), which is attached to the axel (5), and the upper bracket (104), which is attached to the chassis (4). The bottom of the shock absorber (102) is attached to the axle (5) and the top is attached to the chassis (4) The shock absorber (102) is attached to the axle (5) by means of a bottom pin (1021), which protrudes from the end of the shock absorber, is inserted into a hole (1031) in the middle of the lower bracket (103), and is screwed securely into place. The shock absorber (102) is attached to the chassis (4) using an upper pin (1022) that is inserted into a horizontal rod that protrudes from a hole (1041) in the chassis (4) and is screwed securely into place.

The front suspension system (1) includes a coil spring (11), a shock absorber (12) and innovatively designed upper and lower brackets (13) and (14). Drawing No. 1 depicts the front suspension system whereby it is assembled on the chassis (4) and axle (5).

The upper bracket (13) is depicted separately in Drawing No. 2. The upper bracket (13) comprises a vertical rear plate (131), a horizontal bottom plate (132), and two vertical central plates (133) (134), between which is a gap (136), whose function will be explained below. The rear plate (131) has four holes that correspond with the original holes in the chassis (4) and are designed to join and fix the upper bracket (13) to the chassis (4) without having to drill new holes in the chassis. The horizontal bottom plate (132) is, in general, rectangular with a round hole (135) in the center. The round hole (135) is designed to enable the arm of the shock absorber (12) to move from side to side when the vehicle is in motion. The vertical central plates (133) (134) each have two parallel holes: two upper holes (1331) (1341) and two lower holes (1332) (1342), whose function will be explained below.

Drawing No. 3 depicts the bottom bracket (14). The bottom bracket (14) is, in general, a rectangular plate with a hole at each end (141) (142) that correspond with the original holes in the axle (5) and are designed to join and fix the bottom bracket (14) to the axle (5) without having to drill new holes in the axle. Two triangular plates (143) (144) protrude vertically from the middle part of the bottom bracket (4) [the wide base of the triangle is attached to the bottom bracket's main rectangular plate]. A hole (1431) (1441) is located at the top of each of the vertical triangular plates (143) (144). The function of the said holes will be explained below.

The coil spring (11) of the front suspension (1) is the vehicle's original coil spring. The shock absorber (12) of the front suspension (1) is an oil/gas type shock absorber that was developed independently by the inventor and is depicted separately in Drawing No. 4. The shock absorber (12) comprises, in is general, a main cylinder (121), a secondary cylinder (122), and a connecting tube (123).

Attaching the front suspension system (1) to the vehicle: The upper bracket (13) is attached to the chassis (4) by inserting four screws through the four holes in the rear vertical plate (131). The bottom bracket (14) is attached to the axle (5) by inserting two screws through the two holes (141) (142) such that the tips of the two vertical plates (143) (144) protrude from the top part of the axle. The shock absorber (12) is attached by inserting one screw through the holes (1441) and (1431) in the bottom bracket (14) and a second screw through the holes (1331) and (1341) in the top bracket (13). The gap (136) created between the two main vertical plates enables the passage of the connecting tube (123) of the shock absorber (12), as depicted in Drawing No. 2. At this stage, the plate (133) is joined to the plate (134) by inserting a screw through the holes (1332) and (1342) so as to reinforce the hold of the upper bracket (13).

When the invention is implemented on off-road vehicles made by AM General and General Motors of the Hummer series, the coil spring (11) should be the original spring whereas the shock absorber (12) will be an oil/gas absorber with the following (approximate) properties: Decompressed length—490 mm (between hole centers), and braking force—620/350. The inventor's proven experience shows that the front suspension system (1), subject of the invention, offers a good solution to the above-described problem.

Drawing No. 5 depicts the vehicle's standard rear (left) suspension system (200) prior to adaptation, which is, in general, similar to the vehicle's original front suspension system (100).

The rear suspension system (2) is also similar to the front suspension system (1). The difference between the two suspension systems is in the dimensions of the upper and bottom brackets and the braking force of the shock absorber (12) [which is 850/130]. Drawing No. 6 depicts the rear suspension system (2) whereby it is attached to the chassis (4) and to the axle (5).

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

### DESCRIPTION OF THE DRAWINGS

Drawing No. 1 depicts the front suspension system (1).

Drawing No. 2 depicts the upper bracket (13).

Drawing No. 3 depicts the lower bracket (14).

Drawing No. 4 depicts the shock absorber (12).

Drawing No. 5 depicts the vehicle's rear (left) suspension system (200) before adaptation.

Drawing No. 6 depicts the rear suspension system (2).

What is claimed is:

1. A suspension system designed for off-road vehicles that replaces the vehicle's original suspension system and attaches to the vehicle's axle and chassis using the vehicle's original holes. The system includes: Spring coil, shock absorber, upper bracket and lower bracket that attach to original holes in the vehicle's chassis and axle.

2. The suspension system mentioned in claim No. 1 whereby the upper bracket is composed of a vertical rear plate, a horizontal bottom plate, and two vertical middle plates with a gap between them; whereby the rear plate has four holes that correspond to the original holes in the chassis; whereby the horizontal bottom plate has the general shape of a rectangle with a round hole in the middle; and whereby the vertical middle plates each has two parallel holes: two upper holes and two lower holes; and whereby the bottom bracket has the general shape of a rectangular plate with a hole close to each of its ends, which correspond with the original holes in the axle; whereby two vertical, approximately triangular plates protrude from the middle of the bottom bracket; and whereby there is a hole at the top of each of the two vertical plates.

3. The suspension system mentioned in claim No. 1 whereby the said coil spring is the vehicle's original coil spring; whereby the shock absorber comprises a main cylinder, a secondary cylinder, and a connecting tube; and whereby the front suspension system has the following properties: decompressed length—490 mm (between hole centers) and braking force—620/350 and the rear suspension system has a braking force of 850/130.
